(19) United States
(12) Patent Application Publication
(10) Pub. No.: US 2008/0172721 A1
(43) Pub. Date: Jul. 17, 2008

(54) Internet Access Time Control Method Using Authentication Assertion

(76) Inventors: Jong Hyouk Noh, Daejon (KR); Taesung Kim, Daejon (KR); Seung Hyun Kim, Daegu (KR); Dae Seon Choi, Daejon (KR); Sang Rae Cho, Daejon (KR); Yeong Sub Cho, Daejon (KR); Seung Hun Jin, Daejon (KR)

Correspondence Address: LADAS & PARRY LLP, 224 SOUTH MICHIGAN AVENUE, SUITE 1600, CHICAGO, IL, 60604, US

(21) Appl. No.: 11/720,911

(22) PCT Filed: Feb. 24, 2005
(86) PCT No.: PCT/KR2005/000491

§ 371 Date: Oct. 11, 2007

(30) Foreign Application Priority Data
Dec. 7, 2004 (KR) 10-2004-0102497

(51) Int. Cl. G06F 21/20

(52) U.S. Cl. 726/4

(57) ABSTRACT

An Internet access time control method using an authentication assertion is provided. In the method, a user ID is registered in an asserting party site in a single sign-on (SSO) environment by using a user terminal. The asserting party site manages user IDs for providing an SSO service. Control setup values are set in the asserting party site by using the user terminal. Here, the control setup values include an Internet usage duration and an Internet access-restricted time band for the user. A service time of a relying party site accessed by the user terminal is controlled according to an authentication assertion containing the control setup values. Accordingly, the method makes it possible not only to control Internet usage time, but also to prevent the child from unreasonably using the Internet.

### TECHNICAL FIELD

The present invention relates to an Internet access time control method using an authentication assertion, and more particularly, to an Internet access time control method using an authentication assertion, which restricts a user's usage time for a specific Internet site by expressing an Internet usage duration for the user in an authentication assertion in a single sign-on (SSO) environment, restricts an Internet access time band for a user by issuing an authentication assertion suitable for the Internet access time band, and specifically enables a parent to control an Internet usage duration and an Internet access time band for his child by associating the child's identification (ID) with the parent's ID.

### BACKGROUND ART

The Internet is a worldwide information network and a free creative space, which provides many persons with a space for a new opportunity and challenge. However, in addition to such a positive role, the Internet also plays a negative role in that indecent or violent information is rapidly spread in the Internet due to the anonymity, commerciality and addictiveness of the Internet. For preventing the spread of such harmful information, there have been proposed a program for controlling Internet usage/access time, a program for preventing access to a specific Internet site, and an Internet usage time control service managed by an Internet service provider.

Recently, there has been introduced an single sign-on (SSO) technique for authenticating a user accessing a specific Internet site and then providing the user with services of other associated Internet sites without an additional authentication procedure. A typical example of the SSO technique includes an I-Net Passport from Microsoft, an ID-FF from the Liberty Alliance, and a WS-Federation from IBM and Microsoft.

The SSO technique mainly uses an authentication assertion (or an authentication token). The authentication assertion is a kind of guarantee for guaranteeing that a user has been already authenticated when the user accesses another associated Internet site after he accesses an Internet site. That is, when a user is authenticated by an A Internet site, the A Internet site issues an authentication assertion for guaranteeing that the user has been successfully authenticated. Thereafter, when the user accesses an associated B Internet site and provides the authentication assertion to the B Internet site, the B Internet site B determines whether or not the provided authentication assertion has been effectively issued by the A Internet site. If the provided authentication assertion is determined to have been effectively issued, the B Internet site allows the user to use its service without an additional authentication procedure. A typical standard for the authentication assertion includes a security assertion markup language (SAML) from the OASIS Corporation.

However, the conventional Internet usage/access control method cannot control an Internet usage duration discriminatively according to Internet sites, and cannot control an access time band for a specific Internet site discriminatively according to users.

### DISCLOSURE OF INVENTION

### Technical Problem

Accordingly, the present invention is directed to an Internet access time control method using an authentication assertion, which substantially obviates one or more of the problems due to limitations and disadvantages of the related art.

An object of the present invention is to provide an Internet access time control method using an authentication assertion, which can restrict a user's usage time for a specific Internet site by expressing an Internet usage duration for the user in an authentication assertion in an SSO environment.

Another object of the present invention is to provide an Internet access time control method using an authentication assertion, which can restrict an Internet access time band for a user by issuing an authentication assertion suitable for the Internet access time band in an SSO environment.

A further object of the present invention is to provide an Internet access time control method using an authentication assertion, which enables a parent to control an Internet usage duration and an Internet access time band for his child by associating the child's identification (ID) with the parent's ID in an SSO environment.

### Technical Solution

To achieve these and other advantages and in accordance with the purpose of the present invention, as embodied and broadly described, an Internet access time control method using an authentication assertion the method includes the steps of: registering a user ID in an asserting party site in an SSO environment by using a user terminal, the asserting party site managing user IDs for providing an SSO service; setting control setup values in the asserting party site by using the user terminal, the control setup values including an Internet usage duration and an Internet access-restricted time band for the user; and controlling a service time of a relying party site accessed by the user terminal according to an authentication assertion containing the control setup values.

### ADVANTAGEOUS EFFECTS

Accordingly, the inventive Internet access time control method makes it possible to restrict a user's usage time for a specific Internet site by expressing an Internet usage duration for the user in an authentication assertion in an SSO environment, and makes it possible to restrict an Internet access time band for a user by issuing an authentication assertion suitable for the Internet access time band in an SSO environment. Also, the inventive Internet access time control method enables a parent to control an Internet usage duration and an Internet access time band for his child by associating the child's identification (ID) with the parent's ID in an SSO environment, thereby making it possible to prevent the child from unreasonably using the Internet.

### BRIEF DESCRIPTION OF THE DRAWINGS

FIG. 1 is a schematic diagram illustrating an Internet access time control system and method according to an embodiment of the present invention, which issues an authentication assertion to a user accessing an Internet site and then providing the issued authentication assertion to another associated Internet site accessed by the user, thereby providing a service of the associated Internet site to the user without an additional authentication procedure.

### BEST MODE FOR CARRYING OUT THE INVENTION

Hereinafter, preferred embodiments of the present invention will be described in detail with reference to accompanying drawings.

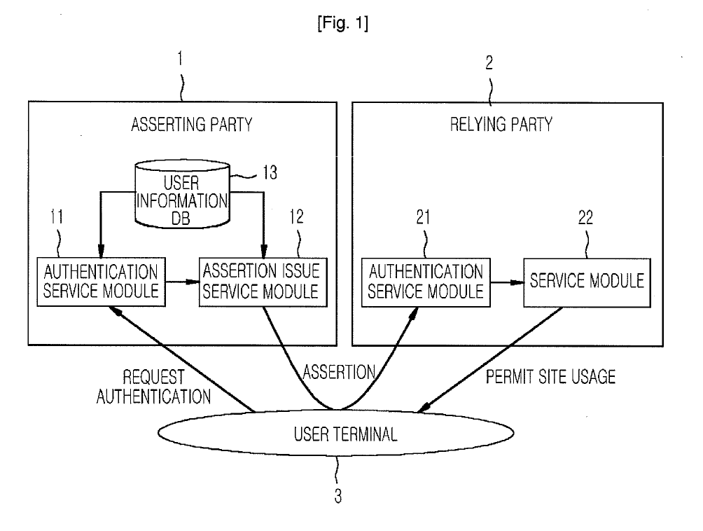

FIG. 1 is a schematic diagram illustrating an Internet access time control system and method according to an embodiment of the present invention, which issues an authentication assertion to a user accessing an Internet site and then provides the issued authentication assertion to another associated Internet site accessed by the user, thereby providing a service of the associated Internet site to the user without an additional authentication procedure.

The Internet access time control system according to the embodiment of the present invention will now be described in detail with reference to FIG. 1.

The Internet access time control system includes an asserting party site (or a site issuing an authentication assertion) 1 for managing IDs for providing an SSO service, a relying party site (or an associated site relying on the issued authentication assertion) 2 for providing an Internet site service to a user, and a user terminal 3.

Here, the asserting party site 1 includes an authentication service module 11, an assertion issue service module 12 and a user information database (DB) 13.

Also, the relying party site 2 includes an authentication service module 21 and a service module 22.

The so-constructed Internet access time control system restricts the use of the Internet according to the age and qualification of users. In detail, the internet access time control system restricts a usage duration for a highly-addictive site such as a game site (for example, a usage duration more than two hours is not allowed for a game site), and restricts an Internet access time band so as to prevent a child from using the Internet late at night (for example, from 10 p.m. through 6 a.m.).

The Internet access time control method according to the embodiment of the present invention will now be described in detail with reference to FIG. 1.

Referring to FIG. 1, when a user registers his ID in the asserting party site 1 by using the user terminal 3, the asserting party site 1 makes the user set a usage duration and an Internet access-restricted time band for a specific site in accordance with the age, qualification and request of the user. At this time, the usage duration data and the Internet access-restricted time band data are stored in the user information DB 13.

First, a method for restricting the usage duration is performed as follows:

When the user receives an issued authentication assertion from the assertion issue service module 12 after being authenticated by the authentication service module 11 with the user terminal 3, the assertion issue service module 12 expresses the usage duration for the specific site in the issued authentication assertion. The relying party site 2 then provides the user with an Internet site service corresponding to the usage duration expressed in the issued authentication assertion. That is, the relying party site 2 prohibits the use of its service by the user when the usage duration elapses. Here, it is preferable that the asserting party site 1 does not reissues an authentication assertion to the user until a given time period elapses from the elapse of the usage duration.

Also, a method for restricting the access time band is performed as follows:

When authenticating the user, the asserting party site 1 determines whether or not a current authentication time is within the Internet access-restricted time band. If the current authentication time is within the access-restricted time band, the asserting party site does not issue an authentication assertion to the user. Unless the current authentication time is within the access-restricted time band, the asserting party site issues an authentication assertion to the user. Here, when issuing an authentication assertion, the asserting party site 1 properly sets a lifetime of the authentication assertion so that the issued authentication assertion may not be effective during the access-restricted time band.

In the meantime, if the user is a child, the asserting party site 1 sets the child to obtain its parent's approval, associates the child's ID with the parent's ID and stores the resulting setup value in the user information DB 13. The storage of such a setup value enables the parent to control an Internet usage duration and an Internet access time band and an harmful Internet site for the child. Also, it is preferably set so that the parent can view the child's Internet access log file.

### INDUSTRIAL APPLICABILITY

As described above, the inventive Internet access time control system and method enables a parent to control an Internet usage duration and an Internet access time band for his child by associating the child's identification (ID) with the parent's ID in an SSO environment, thereby making it possible to prevent the child from unreasonably using the Internet.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. An Internet access time control method using an authentication assertion, the method comprising the steps of:
(a) registering a user ID in an asserting party site in a single sign-on (SSO) environment by using a user terminal, the asserting party site managing user IDs for providing an SSO service;
(b) setting control setup values in the asserting party site by using the user terminal, the control setup values including an Internet usage duration and an Internet access-restricted time band for the user; and
(c) controlling a service time of a relying party site accessed by the user terminal according to an authentication assertion containing the control setup values.

2. The method of claim 1, wherein the step (a) comprises the steps of:
requesting service use for the relying party site at the user terminal;
transmitting the authentication assertion containing the control setup values from the asserting party site to the relying party site; and
controlling the Internet usage duration and the Internet access-restricted time band according to the control setup values.

3. The method of claim 2, wherein the step of controlling the Internet usage duration comprises the steps of:
counting the service time of the relying party site; and
restricting the service of the relying party site if the counted service time equal to or larger than a preset value.

4. The method of claim 3, wherein re-access to the relying party site is performed after a preset time from the time of the service restriction under the control of the asserting party site.

5. The method of claim 2, wherein the step of controlling the Internet access-restricted time band comprises the steps of:
checking at the asserting party site a current time when the user terminal requests service use for the relying party site; and
stopping issuing an authentication assertion at the asserting party site if the current time is within the Internet access-restricted time band.

6. The method of claim 5, further comprising the steps of:
issuing an authentication assertion at the asserting party unless the current time is within the Internet access-restricted time band; and
setting the authentication assertion to be ineffective during the Internet access-restricted time band by setting a lifetime of the authentication assertion when issuing the authentication assertion.

7. The method of the claim 1, wherein the control setup values is set to associate the ID with a plurality of other IDs, whereby an Internet usage duration and an Internet access-restricted time band and a harmful site list for the other IDs are able to be controlled.
